(19) United States
(12) Patent Application Publication
(10) Pub. No.: US 2025/0236292 A1
(43) Pub. Date: Jul. 24, 2025

(54) PERFECT CRUISE CONTROL

(71) Applicant: SoftBank Group Corp., Tokyo (JP)

(72) Inventor: Masayoshi SON, Tokyo (JP)

(21) Appl. No.: 19/170,066

(22) Filed: Apr. 4, 2025

Related U.S. Application Data
(63) Continuation of application No. PCT/JP2023/035739, filed on Sep. 29, 2023.

(30) Foreign Application Priority Data
Oct. 4, 2022 (JP) 2022-160567
Oct. 4, 2022 (JP) 2022-160578
Oct. 6, 2022 (JP) 2022-161873

(51) Int. Cl. B60W 30/14; B60W 50/00

(52) U.S. Cl. CPC B60W 30/143; B60W 50/0097; B60W 2540/215; B60W 2552/00; B60W 2552/40; B60W 2555/20

(57) ABSTRACT

There is provided a control apparatus which controls a vehicle, the control apparatus including an information acquisition unit which acquires multiple pieces of information, and a control unit which controls, at a very high speed, a speed of the vehicle by using the multiple pieces of information acquired by the information acquisition unit. The control unit controls the vehicle in billionths of a second by using the multiple pieces of information. According to the control apparatus, since AI foresees an emergency, perfect stop is possible without needs for braking and without spilling a glass of water. In addition, power consumption is low, and brake friction does not occur.

### BACKGROUND

### 1. Technical Field

The present invention relates to perfect cruise control and a system which predicts a puddle and an icing condition of a road based on speed control in a safety control system for ultra high performance automated driving, an angle of the road, dent data, and rainfall and snowfall amount information.

### 2. Related Art

Patent Document 1 describes a vehicle having an automated driving function.

### PRIOR ART DOCUMENTS

### Patent Document

Patent Document 1: Japanese Patent Application Publication No. 2022-035198

### BRIEF DESCRIPTION OF THE DRAWINGS

FIG. 1 schematically illustrates a danger prediction ability of AI of ultra high performance automated driving.

FIG. 2 schematically illustrates a central brain SoC (system on chip) in the ultra high performance automated driving.

FIG. 3 schematically illustrates perfect speed control.

FIG. 4 schematically illustrates perfect bell curves.

FIG. 5 is an overview diagram of perfect cruising.

FIG. 6 is an overview diagram of the perfect cruising.

FIG. 7 is an overview diagram of the perfect cruising.

FIG. 8 is an overview diagram of the perfect cruising.

FIG. 9 is an overview diagram of the perfect cruising.

FIG. 10 is an overview diagram of the perfect cruising.

FIG. 11 is an overview diagram of the perfect cruising.

FIG. 12 schematically illustrates an example of a functional configuration of a control apparatus 100 which controls a vehicle.

FIG. 13 schematically illustrates an example of a hardware configuration of a computer 1200 which functions as the central brain SoC and the control apparatus.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

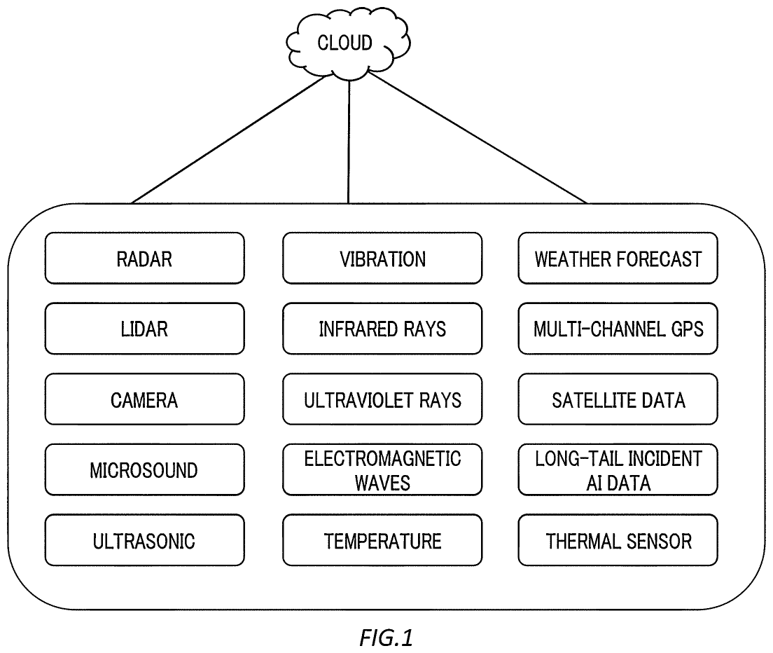

FIG. 1 schematically illustrates a danger prediction ability of AI in ultra high performance automated driving according to the present embodiment. In the present embodiment, multiple types of sensor information are converted into AI data to be accumulated in a cloud. AI predicts and determines a best mix of conditions for every nanosecond to optimize a vehicle operation.

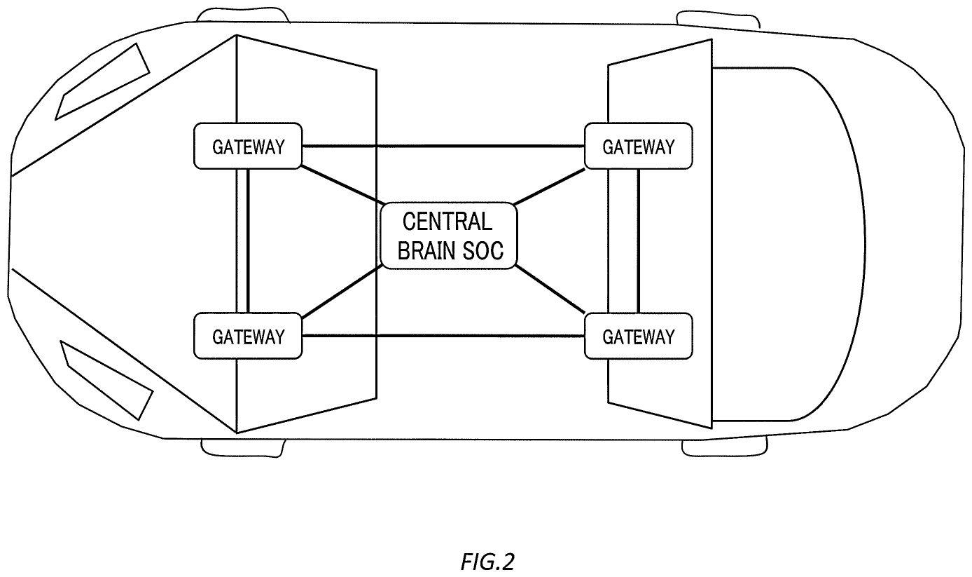

FIG. 2 schematically illustrates a central brain SoC in the ultra high performance automated driving. The central brain SoC may be an example of a control apparatus.

Examples of a sensor used in the present embodiment include radar, LiDAR, a high pixel, telephoto, ultra wide angle, 360-degree, high performance camera, vision recognition, microsound, ultrasonic, vibration, infrared rays, ultraviolet rays, electromagnetic waves, a temperature, a humidity, spot AI weather forecast, high precision multi-channel GPS, low altitude satellite information, long tail incident AI data, and the like. The long tail incident AI data is trip data of a Level 5 implemented automobile.

Examples of sensor information taken from multiple types of sensors include body weight gravity center movement, road material sensing, road angle sensing, road dent sensing, outside air temperature sensing, outside air humidity sensing, up, down, lateral, and diagonal inclination slope angle sensing, road icing manner, water content sensing, sensing of materials, wearing conditions, and air pressures of respective tires, road widths, presence or absence of overtaking prohibition, oncoming vehicles, vehicle model information of front and rear vehicles, cruising states of those vehicles, surrounding conditions (such as a bird, an animal, a soccer ball, a vehicle involved in an accident, an earthquake, fire, wind, typhoon, heavy rain, shower, snow storm, fog, a direction (such as southwest or northeast), a leaf color and a leaf volume of trees growing around the road, and the like, and in the present embodiment, sensing of these is implemented every nanosecond. The control apparatus transmits these pieces of sensor information to the cloud to be accumulated on the cloud side. The control apparatus may transmit the road material, the road angle, the road dent, and the road surrounding condition to the cloud each time the vehicle (tires) passes on the road. The control apparatus may execute a calculation using the sensor information and transmit a calculation result to the cloud. For example, the control apparatus calculates an amount of sunlight in a surrounding area based on the direction, the leaf color, and the leaf volume of trees growing around the road and transmits a calculation result to the cloud. The cloud accumulates the road angle, unevenness data, data of the amount of sunlight, real time weather forecast, rainfall and snowfall amounts, and the like.

The control apparatus executes various types of control by using these pieces of information. The control apparatus may acquire the information accumulated in the cloud and perform various types of calculations to execute various types of control. Various types of calculations using these pieces of information may be performed on the cloud side based on an instruction from the control apparatus, and calculation results may be transmitted to the control apparatus to execute various types of control by using the calculation results received by the control apparatus. The control apparatus and the cloud may execute the calculations in a distributed manner.

In the present embodiment, the control apparatus may execute, from these pieces of information, matching with most correctly predicted weather forecast for each smallest spot based on the entire road+AI. The control apparatus may execute, from these pieces of information, matching with position information of another vehicle. The control apparatus may execute, from these pieces of information, matching with a best estimated vehicle model (matching with a remaining amount on its way and a speed for every nanosecond). The control apparatus may execute, from these pieces of information, matching with a mood such as music to which a passenger listens. The control apparatus may execute, from these pieces of information, instantaneous reconfiguration of conditions when the mood of the desire changes.

The control apparatus may calculate how a condition of the road changes as the vehicle travels to predict an optimal road by appropriately combining the information stored in the cloud. For example, the control apparatus predicts a puddle when rain is forecast by using the information of the road shape and the information of the amount of sunlight. For example, the control apparatus predicts road icing when snow is forecast by using the information of the road shape and the information of the amount of sunlight. The control apparatus may control the vehicle so as to avoid the puddle or icy part following a prediction result or adjust a course of the vehicle or adjust a driving speed of the vehicle according to an extent, size, or the like of the puddle or icy part.

The control apparatus may upload the AI data to the cloud when vehicle is changed, for example. A data lake is formed to be analyzed by AI and regularly uploaded up to date.

The control apparatus may use both a software aspect and a hardware aspect as a method to optimize the travel of the vehicle. On the software aspect, the control apparatus performs best mix of all of the information accumulated in the cloud and the automobile sensor information by AI to be determined by AI every nanosecond to achieve automated driving meeting the desire of the passenger. On the hardware aspect, the vehicle performs micro control on a motor rotation output every 1/1 billion second (nanosecond). The vehicle includes electricity and a motor that enable communication and control in nanosecond. According to the control apparatus, since AI foresees an emergency, perfect stop is possible without needs for braking and without spilling a glass of water. In addition, power consumption is low, and brake friction does not occur.

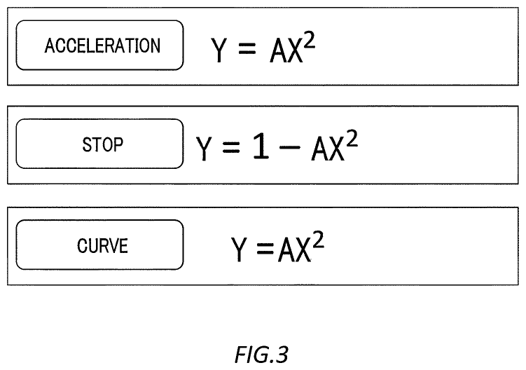

FIG. 3 schematically illustrates perfect speed control achieved through control by the control apparatus according to the present embodiment. A principle illustrated in FIG. 3 is an indicator to calculate a braking distance of the vehicle, which is controlled by this basic equation. In the system according to the present embodiment, since ultra high performance input data is present, the calculation can be performed with clean bell curves.

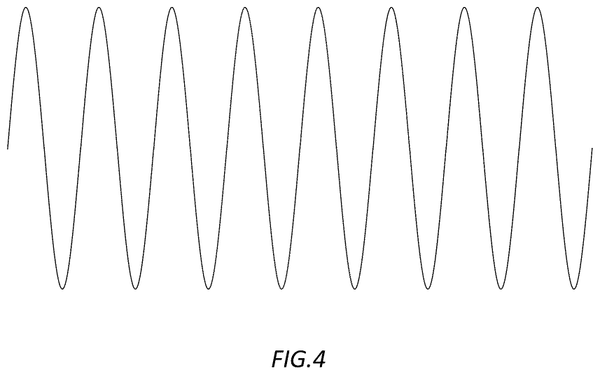

FIG. 4 schematically illustrates perfect bell curves achieved through the control by the control apparatus according to the present embodiment.

1 million TOPS can be achieved as a computing speed when ultra high performance automated driving is achieved.

As described above, in the present embodiment, the control apparatus may achieve perfect cruise control. A brain of the control apparatus may execute control according to a preference of an occupant riding in the vehicle. Examples of the preference of the occupant include “a shortest period of time”, “a longest remaining battery life”, “wanting to avoid vehicle sickness most of all”, “wanting to feel G most of all (safely)”, “wanting to feel a landscape most of all with a mix of the above and the like”, “wanting to feel a different landscape from the last time”, “for example, wanting to trace memories of a road coming down with someone some years ago”, “wanting to minimize a probability of an accident most of all”, and the like, and the brain discusses various other conditions with the passenger. The brain executes perfect mix with the vehicle based on a number of passengers, a weight, a location, body weight gravity center movement (calculated every nanosecond), sensing of the road material for every nanosecond, sensing of the outside air temperature for every nanosecond, sensing of the outside air humidity for every nanosecond, and the above-described condition selections in total for every nanosecond.

The brain may take into account or execute “the up, down, lateral, and diagonal inclination slope angles of the road”, “matching with the most correctly predicted weather forecast for each smallest spot by AI on its entire way”, “matching with the position information of another vehicle for every nanosecond”, “matching with the best estimated vehicle model of those (the remaining amount on its way and the speed for every nanosecond matching)”, “matching with the mood such as the music to which the passenger listens”, “the instantaneous reconfiguration of the conditions when the mood of the desire changes”, “the estimation of the optimal mix with the remaining road and the road icing manner, the water content, and the material wearing and the air pressure of each of the four, two, eight, or 16 tires or the like for that every nanosecond”, “the lane width, the angle, and whether or not this is a no-overtaking lane of the road at that time”, “the vehicle models in the opposite lane and the front and rear lanes and the cruising states of the vehicles (for every nanosecond)”, and “the best mix of all other conditions”.

Positions to take within the width of each lane are all different instead of being in the middle. The positions depend on the speed, the angle, and the road information at the time. For example, best probability inference matching of a flying bird, an animal, an oncoming vehicle, a soccer ball that comes flying in, a child, a vehicle involved in an accident, an earthquake, fire, wind, typhoon, heavy rain, shower, snow storm, fog, and other nanosecond-by-nanosecond impacts is executed.

Perfect matching of capabilities of a current version of the brain and the latest updated brain cloud accumulated up to that time point is executed.

This may be defined as perfect cruising in the ultra high performance automated driving. For this reason, in the ultra high performance automated driving, 1 million TOPS requires a best battery power management and a temperature AI synchronized burst chilling function at that time.

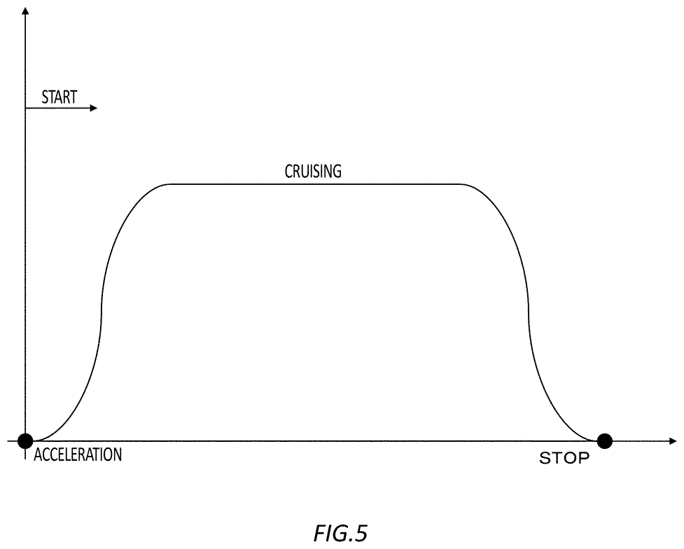

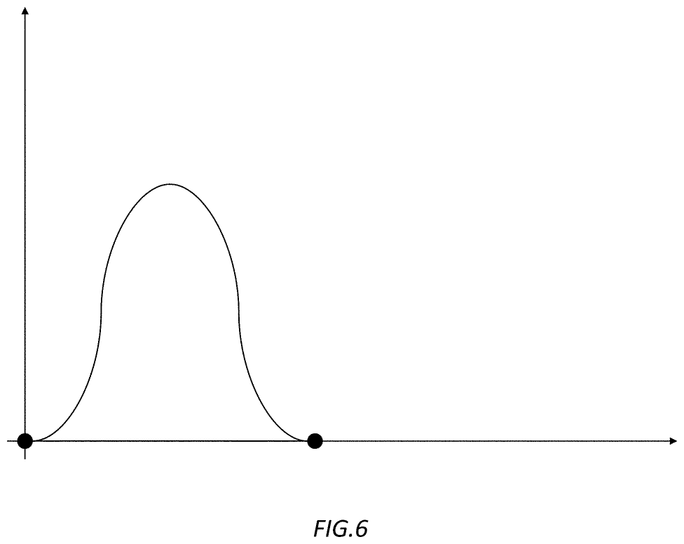

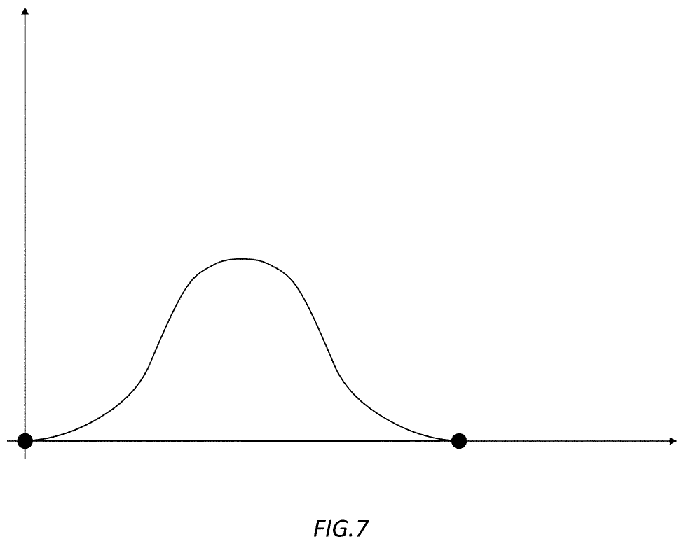

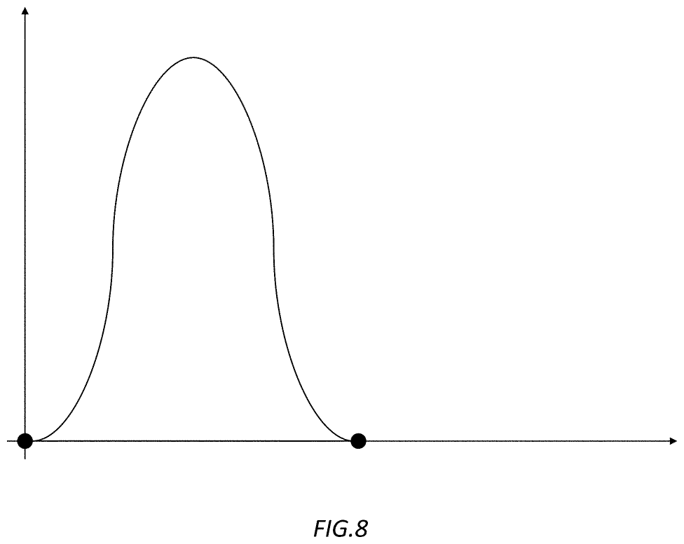

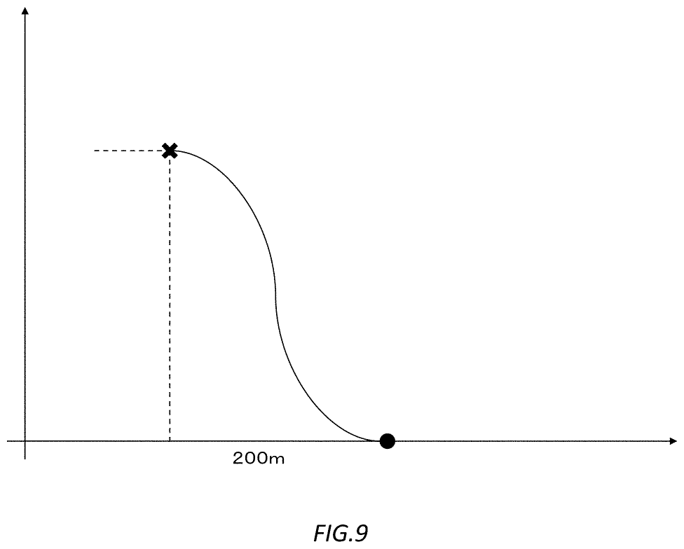

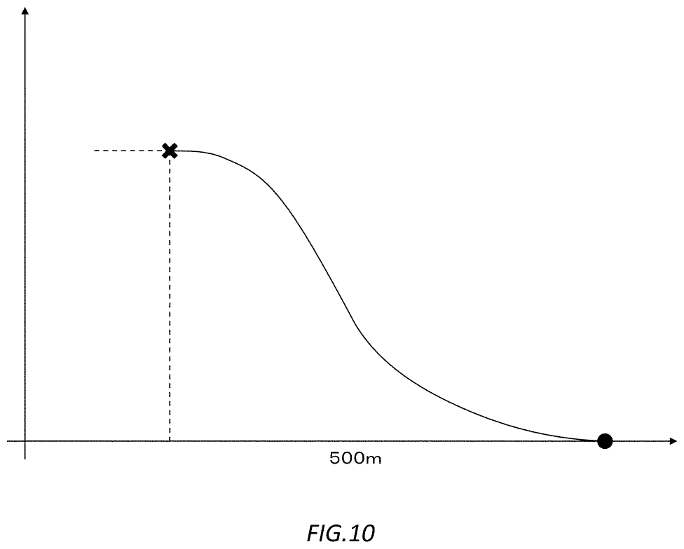

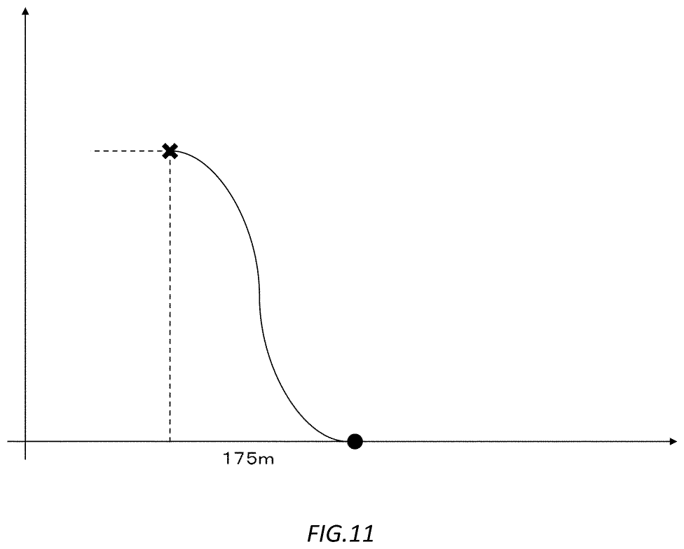

FIG. 5, FIG. 6, FIG. 7, FIG. 8, FIG. 9, FIG. 10 and FIG. 11 are overview diagrams of the perfect cruising.

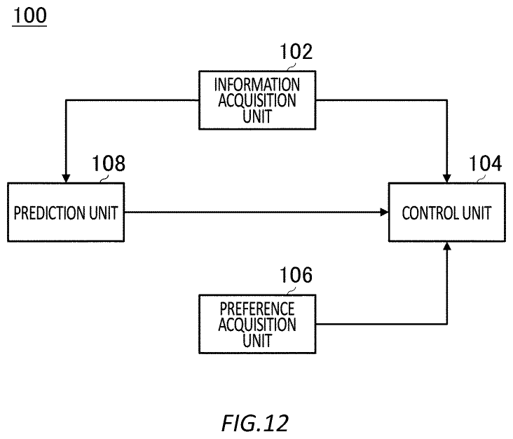

FIG. 12 schematically illustrates an example of a functional configuration of a control apparatus 100 which controls a vehicle. The control apparatus 100 includes an information acquisition unit 102, a control unit 104, a preference acquisition unit 106, and a prediction unit 108. Note that the control apparatus 100 may not necessarily include all of these components.

The information acquisition unit 102 acquires multiple pieces of information. For example, the information acquisition unit 102 acquires multiple pieces of information from multiple types of sensors. For example, the information acquisition unit 102 acquires the body weight gravity center movement. For example, the information acquisition unit 102 acquires sensing of the road material. For example, the information acquisition unit 102 acquires a sensing result of the road angle. For example, the information acquisition unit 102 acquires a sensing result of the road dent. For example, the information acquisition unit 102 acquires a sensing result of the outside air temperature. For example, the information acquisition unit 102 acquires a sensing result of the outside air humidity. For example, the information acquisition unit 102 acquires sensing results of the up, down, lateral, and diagonal inclination slope angles. For example, the information acquisition unit 102 acquires the road icing manner. For example, the information acquisition unit 102 acquires a sensing result of the water content. For example, the information acquisition unit 102 acquires sensing results of the material, the wearing condition, and the air pressure of each tire. For example, the information acquisition unit 102 acquires the road width. For example, the information acquisition unit 102 acquires the presence or absence of overtaking prohibition. For example, the information acquisition unit 102 acquires the oncoming vehicle information. For example, the information acquisition unit 102 acquires the vehicle model information of the front and rear vehicles. For example, the information acquisition unit 102 acquires the cruising states of those vehicles. For example, the information acquisition unit 102 acquires information of the surrounding conditions (such as a bird, an animal, a soccer ball, a vehicle involved in an accident, an earthquake, fire, wind, typhoon, heavy rain, shower, snow storm, fog, a direction (such as southwest or northeast), a leaf color, and a leaf volume of trees growing around the road, and the like). The information acquisition unit 102 may acquire the information accumulated in the cloud.

The control unit 104 controls, at a very high speed, a speed of the vehicle by using the multiple pieces of information acquired by the information acquisition unit 102 and AI. The control unit 104 may control the vehicle in billionths of a second by using the multiple pieces of information and AI.

For example, the control unit 104 may execute, from the information acquired by the information acquisition unit 102, matching with the most correctly predicted weather forecast for each smallest spot based on the entire road+AI. For example, the information acquisition unit 102 may execute, from the information acquired by the control unit 104, matching with position information of another vehicle. For example, the control unit 104 may execute, from the information acquired by the information acquisition unit 102, matching with the best estimated vehicle model (matching with the remaining amount on its way and the speed for every nanosecond). The control apparatus may execute, from these pieces of information, matching with the mood such as the music to which the passenger listens.

The preference acquisition unit 106 acquires a preference of an occupant of the vehicle. For example, the preference acquisition unit 106 acquires the preference of the occupant includes “the shortest period of time”, “the longest remaining battery life”, “wanting to avoid vehicle sickness most of all”, “wanting to feel G most of all (safely)”, “wanting to feel the landscape most of all with the mix of the above and the like”, “wanting to feel a different landscape from the last time”, “for example, wanting to trace the memories of the road coming down with someone some years ago”, “wanting to minimize the probability of the accident most of all”, or the like.

The control unit 104 may execute vehicle control according to the preference of the occupant which is acquired by the preference acquisition unit 106 by using the multiple pieces of information acquired by the information acquisition unit 102 and AI. For example, to fulfil the preference of the occupant, the control unit 104 executes perfect mix with the vehicle based on the number of passengers, the weight, the location, the body weight gravity center movement (calculated every nanosecond), the sensing of the road material for every nanosecond, the outside air temperature sensing for every nanosecond, the outside air humidity sensing for every nanosecond, and the above-described condition selections in total for every nanosecond. The control unit 104 may take into account or execute “the up, down, lateral, and diagonal inclination slope angles of the road”, “the matching with the most correctly predicted weather forecast for each smallest spot by AI on its entire way”, “the matching with the position information of another vehicle for every nanosecond”, “the matching with the best estimated vehicle model of those (the remaining amount on its way and the speed for every nanosecond matching)”, “the matching with the mood such as the music to which the passenger listens”, “the instantaneous reconfiguration of the conditions when the mood of the desire changes”, “the estimation of the road icing manner, the water content, the material wearing and the air pressure of each of four, two, eight, or 16 tires or the like, and the optimal mix of the remaining road for that every nanosecond”, “the lane width, the angle, and whether or not this is a no-overtaking lane of the road at that time”, “the vehicle models in the opposite lane and the front and rear lanes and the cruising states of the vehicles for every nanosecond”, and “the best mix of all other conditions”.

The prediction unit 108 predicts a condition of the road on which the vehicle travels by using the multiple pieces of information acquired by the information acquisition unit 102 and AI. The prediction unit 108 may predict the condition of the road in billionths of a second by using the multiple pieces of information and AI. The prediction unit 108 may calculate how the condition of the road changes as the vehicle travels to predict an optimal road by appropriately combining the information stored in the cloud. For example, the information acquisition unit 102 acquires the information of the road shape and the information of the amount of sunlight, and the prediction unit 108 predicts a puddle when rain is forecast. For example, the information acquisition unit 102 acquires the information of the road shape and the information of the amount of sunlight, and the prediction unit 108 predicts road icing when snow is forecast. The control unit 104 may control the vehicle to avoid the puddle or icy part following a prediction result by the prediction unit 108 or adjust the course of the vehicle or adjust the driving speed of the vehicle according to the extent, size, or the like of the puddle or icy part.

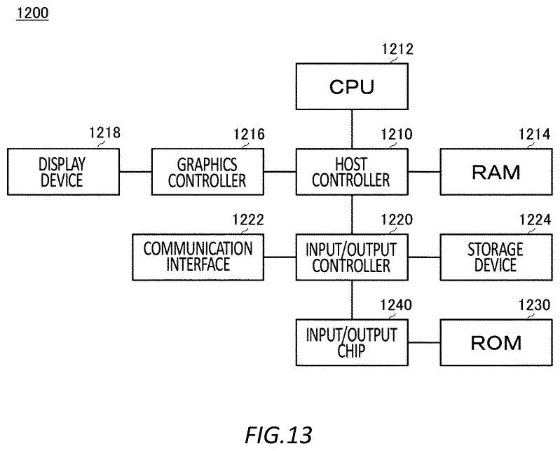

FIG. 13 schematically illustrates an example of a hardware configuration of a computer 1200 that functions as the central brain SoC or the control apparatus. A program installed in the computer 1200 can cause the computer 1200 to function as one or more “units” of an apparatus according to the present embodiment, or cause the computer 1200 to perform operations associated with the apparatus or perform one or more “units” thereof according to the present embodiment, and/or cause the computer 1200 to perform the process according to the present embodiment or perform the steps of the process. Such a program may be executed by a CPU 1212 to cause the computer 1200 to perform particular operations associated with some or all of the blocks in the flowcharts and block diagrams described in the present specification.

The computer 1200 according to the present embodiment includes the CPU 1212, a RAM 1214, and a graphics controller 1216, which are connected to each other via a host controller 1210. The computer 1200 also includes input/output units such as a communication interface 1222, a storage device 1224, a DVD drive and an IC card drive, which are connected to the host controller 1210 via an input/output controller 1220. The DVD drive may be a DVD-ROM drive, a DVD-RAM drive, and the like

The storage device 1224 may be a hard disk drive, a solid-state drive, and the like. The computer 1200 also includes a ROM 1230 and a legacy input/output unit such as a keyboard, which are connected to the input/output controller 1220 via an input/output chip 1240.

The CPU 1212 operates in accordance with the programs stored in the ROM 1230 and the RAM 1214, thereby controlling each unit. The graphics controller 1216 obtains image data which is generated by the CPU 1212 in a frame buffer or the like provided in the RAM 1214 or in itself so as to cause the image data to be displayed on a display device 1218.

The communication interface 1222 communicates with other electronic devices via a network. The storage device 1224 stores a program and data used by the CPU 1212 in the computer 1200. The DVD drive reads the programs or the data from the DVD-ROM or the like, and provides the storage device 1224 with the programs or the data. The IC card drive reads the program and data from an IC card, and/or writes the program and data to the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, or the like to the input/output controller 1220.

A program is provided by a computer readable storage medium such as the DVD-ROM or the IC card. The program is read from the computer readable storage medium, installed into the storage device 1224, RAM 1214, or ROM 1230, which are also examples of a computer readable storage medium, and executed by the CPU 1212. Information processing written in these programs is read by the computer 1200, and provides cooperation between the programs and the various types of hardware resources described above. An apparatus or method may be configured by implementing the operation or processing of information in accordance with the usage of the computer 1200.

For example, when a communication is performed between the computer 1200 and an external device, the CPU 1212 may execute a communication program loaded in the RAM 1214 and instruct the communication interface 1222 to perform communication processing based on a process written in the communication program. The communication interface 1222, under control of the CPU 1212, reads transmission data stored on a transmission buffer region provided in a recording medium such as the RAM 1214, the storage device 1224, the DVD-ROM, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive (DVD-ROM), the IC card, and the like, and perform various types of processing on the data on the RAM 1214. Next, the CPU 1212 may write the processed data back into the external recording medium.

Various types of information, such as various types of programs, data, tables, and databases, may be stored in the recording medium to undergo information processing. The CPU 1212 may execute, on the data read from the RAM 1214, various types of processing including various types of operations, information processing, conditional judgement, conditional branching, unconditional branching, information search/replacement, or the like described throughout the present disclosure and designated by instruction sequences of the programs, to write the results back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the said plurality of entries, and read the attribute value of the second attribute stored in the said entry, thereby obtaining the attribute value of the second attribute associated with the first attribute that satisfies a predetermined condition.

The above described program or software modules may be stored in the computer readable storage medium on or near the computer 1200. In addition, a recording medium such as a hard disk or a RAM provided in a server system connected to a dedicated communication network or the Internet can be used as the computer readable storage medium, thereby providing the program to the computer 1200 via the network.

Blocks in flowcharts and block diagrams in the present embodiments may represent stages of processes in which operations are executed or “units” of apparatuses responsible for executing operations. A specific step and “unit” may be implemented by a dedicated circuit, a programmable circuit supplied along with a computer readable instruction stored on a computer readable storage medium, and/or a processor supplied along with the computer readable instruction stored on the computer readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer readable storage medium may include any tangible device capable of storing an instruction executed by an appropriate device, so that the computer readable storage medium having the instruction stored thereon constitutes a product including an instruction that may be executed in order to provide means for executing an operation designated by a flowchart or a block diagram. An example of the computer readable storage medium may include an electronic storage medium, a magnetic storage medium, an optical storage medium, an electromagnetic storage medium, a semiconductor storage medium, and the like

A more specific example of the computer readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as Smalltalk (registered trademark), JAVA (registered trademark), and C++, or the like, and a conventional procedural programming language such as a “C” programming language or a similar programming language.

The computer readable instruction may be provided to a general purpose computer, a special purpose computer, or a processor or programmable circuit of another programmable data processing device locally or via a local area network (LAN), a wide area network (WAN) such as the Internet or the like in order that the general purpose computer, the special purpose computer, or the processor or the programmable circuit of another programmable data processing device executes the computer readable instruction to generate means for executing operations designated by the flowchart or the block diagram. Examples of the processor include a computer processor, a processing unit, a microprocessor, a digital signal processor, a controller, a microcontroller, and the like.

While the present invention has been described above by way of the embodiments, the technical scope of the present invention is not limited to the above-described embodiments. It is apparent to persons skilled in the art that various alterations or improvements can be added to the above-described embodiments. It is also apparent from the scope of the claims that the embodiments added with such alterations or improvements can be included in the technical scope of the present invention.

The operations, procedures, steps, and stages of each process performed by a device, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

100: control apparatus; 102: information acquisition unit; 104: control unit; 106: preference acquisition unit; 108: prediction unit; 1200: computer; 1210: host controller; 1212: CPU; 1214: RAM; 1216: graphics controller; 1218: display device; 1220: input/output controller; 1222: communication interface; 1224: storage device; 1230: ROM; 1240: input/output chip.

1. A control apparatus which controls a vehicle, the control apparatus comprising:
an information acquisition unit which acquires multiple pieces of information; and
a control unit which controls, at a very high speed, a speed of the vehicle by using the multiple pieces of information acquired by the information acquisition unit and AI.

2. The control apparatus according to claim 1, wherein the control unit controls the vehicle in billionths of a second by using the multiple pieces of information and AI.

3. A control apparatus which controls a vehicle, the control apparatus comprising:
an information acquisition unit which acquires multiple pieces of information;
a preference acquisition unit which acquires a preference of an occupant of the vehicle; and
a control unit which executes control of the vehicle according to the preference of the occupant by using the multiple pieces of information acquired by the information acquisition unit and AI.

4. The control apparatus according to claim 3, wherein the control unit controls the vehicle in billionths of a second by using the multiple pieces of information and AI.

5. A control apparatus which controls a vehicle, the control apparatus comprising:
an information acquisition unit which acquires multiple pieces of information; and
a prediction unit which predicts a condition of a road on which the vehicle travels by using the multiple pieces of information acquired by the information acquisition unit and AI.

6. The control apparatus according to claim 5, wherein the prediction unit predicts the condition of the road in billionths of a second by using the multiple pieces of information and AI.

7. The control apparatus according to claim 5, wherein the information acquisition unit acquires information of a shape of a road and information of an amount of sunlight, and the prediction unit predicts a puddle when rain is forecast.

8. The control apparatus according to claim 5, wherein the information acquisition unit acquires information of a shape of a road and information of an amount of sunlight, and the prediction unit predicts road icing when snow is forecast.

9. A non-transitory computer readable storage medium storing a program for causing a computer to function as a control apparatus which controls a vehicle, the control apparatus including an information acquisition unit which acquires multiple pieces of information, and a control unit which controls, at a very high speed, a speed of the vehicle by using the multiple pieces of information acquired by the information acquisition unit and AI.

10. A non-transitory computer readable storage medium storing a program for causing a computer to function as a control apparatus which controls a vehicle, the control apparatus comprising:
an information acquisition unit which acquires multiple pieces of information;
a preference acquisition unit which acquires a preference of an occupant of the vehicle; and
a control unit which executes control the vehicle according to the preference of the occupant by using the multiple pieces of information acquired by the information acquisition unit and AI.

11. A non-transitory computer readable storage medium storing a program for causing a computer to function as a control apparatus which controls a vehicle, the control apparatus including an information acquisition unit which acquires multiple pieces of information, and a prediction unit which predicts a condition of a road on which the vehicle travels by using the multiple pieces of information acquired by the information acquisition unit and AI.
